(19) United States
(12) Patent Application Publication
(10) Pub. No.: US 2007/0021156 A1
(43) Pub. Date: Jan. 25, 2007

(54) Compact radio communications device

(76) Inventors: Chow Tatt Hoong, Singapore (SG); Steve C. Emmert, Crystal Lake, IL (US); Manoj Govindan, Singapore (SG)

Correspondence Address: MOTOROLA INC, 600 NORTH US HIGHWAY 45, ROOM AS437, LIBERTYVILLE, IL, 60048-5343, US

(21) Appl. No.: 11/184,207

(22) Filed: Jul. 19, 2005

(51) Int. Cl. H04M 3/00

(52) U.S. Cl. 455/575.1

(57) ABSTRACT

A radio communications device (100) comprising a chassis (102) having an outer frame with a partition (106). There is a substantially rigid housing that in combination with partition (106) form a user interface chamber (410) and one other chamber (420). A keypad switch mount (130) supports a plurality of switch contacts (132) aligned with respective keypad keys (134), the keypad switch mount being disposed in the user interface component chamber (410). A display screen (140 is also disposed in the user interface component chamber (410) and and a battery chamber (430) is formed in the other component chamber (420) adjacent a circuit substrate (150) having surface mounted processor and transceiver circuitry ((160, 260).

### FIELD OF THE INVENTION

The present invention relates generally to radio communications devices, and in particular to compact radio communications devices having a form factor often referred to a “candy bar” form factor.

### BACKGROUND

Portable handheld radio communications devices (e.g. cellphones) that are easy to transport are becoming commonplace. Such communications devices come in a variety of different form factors such as “clam shell”, “flip phones” and “candy bar” and they support many features and functions.

For purposes of convenience there is a general trend toward miniaturization of many types of handheld electronic devices, specifically handheld radio communications devices. Miniaturization provides for convenience as it generally makes these devices easier to carry the device, including fitting the device into a user's pocket/purse or attaching the device to a user's belt by use of a holster or pouch. Also, miniaturization can provide visual appeal and elegance that are often desired attributes for radio communications devices.

### SUMMARY OF THE INVENTION

According to one aspect of this invention there is provided a radio communications device comprising a chassis having an outer frame with at least one partition disposed therein. There is a substantially rigid housing having at least a user interface housing member and at least one opposite housing member, the user interface housing member being mounted to the chassis to form at least one user interface component chamber with the with a first surface of the partition, and the opposite housing member being mounted to the chassis to form at least one other chamber with the with a second surface of the partition.

A keypad switch mount supports a plurality of switch contacts aligned with respective keypad keys, the keypad switch mount being disposed in the user interface component chamber and supported by the first surface of the partition. A display screen is disposed in the user interface component chamber and supported by the first surface of the partition and a battery chamber is formed in the other component chamber. There is at least one circuit substrate with processor and transceiver circuitry mounted thereon, the substrate being disposed in the other component chamber and supported by the second surface of the partition.

### BRIEF DESCRIPTION OF THE FIGURES

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is an exploded front view of a radio communications device in accordance with an embodiment of the invention;

FIG. 2 is an exploded rear view of the radio communications device in of FIG. 1;

FIG. 3 is a front plan view of the radio communications device in of FIG. 1 when assembled; and

FIG. 4 is an area cross sectional view through 3-3′ of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in a radio communications device. Accordingly, the radio communications device has been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a device that comprises a list of elements does not include only those elements but may include other elements not expressly listed or inherent to such devices. An element proceeded by “comprises . . . a” does not, without more constraints, preclude the existence of additional identical elements in the device.

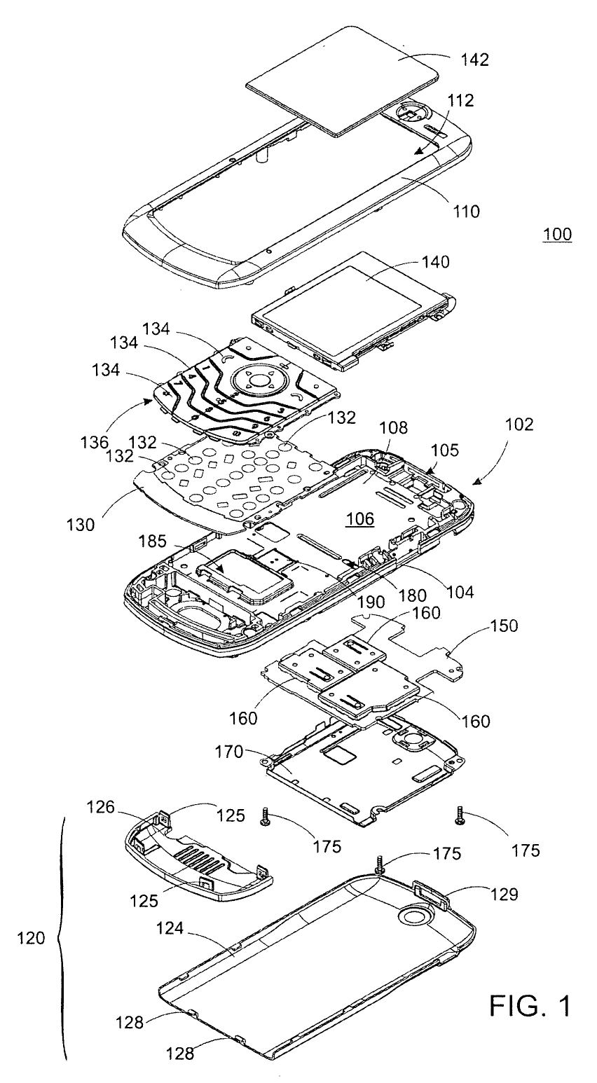

Referring to FIG. 1, there is illustrated an exploded front view of a radio communications device 100. The radio communications device 100 has a chassis 102 having an outer frame 104 with a partition 106 disposed inside the frame 104. The partition 106 is formed from a metal sheet and is therefore electrically conductive and forms a ground plane for the device 100. The partition 106 is mounted to the outer frame 104 by a composite molding process and the partition 106 has a first surface 108 that has an area that provides a substantially planar surface.

The device 100 further comprises a substantially rigid housing (with a “candy bar” type form factor) having a user interface housing member 110 with a lens and keypad aperture 112. The substantially rigid housing also has an opposite housing member 120 formed from a removable latched cover 124 and speaker chamber cover 126. The speaker chamber cover 126 has four resilient snap fitment members 125 for snap fitment engagement with protrusions on the chassis 102 to thereby mount the chamber cover 126 onto the chassis. Also, the removable latched cover 124 has two shouldered protrusions 128 for engaging with an inner surface of the speaker chamber cover 126, and at an opposite end the removable latched cover 124 has a socket 129 for engaging with a biased latch member (not illustrated) located at latching region 105 the chassis 102. Hence, in use and when the chamber cover 126 is mounted onto the chassis 102, the shouldered protrusions 128 engage with the inner surface of the speaker chamber cover and function like a hinge during mounting and dismounting of the removable latched cover 124 to the chassis.

A keypad switch mount 130, typically a printed circuit board, supports a plurality of switch contacts disposed inside poppel (domed) switches 132 that are aligned with respective keypad keys 134 of a keypad 136. A display screen 140 and associated screen lens 142 are also illustrated. The device 100 has a circuit substrate 150 with processor and transceiver circuitry 160 (or other circuitry formed in an integrated circuit packages) surface mounted to the substrate 150, and a metal cover 170 is attached to the circuit substrate 150 by fixing screws 175.

Returning to the partition 106, there is a removable memory card apertured region 185 with an adjacent sliding lock 190 for securing a Subscriber Identity Module (SIM) card or any other similar card or smartcard to the partition. There is also a slot 180 in the partition 106 for allowing electrical wiring to connect between, for instance, the switches 132 and circuitry 160.

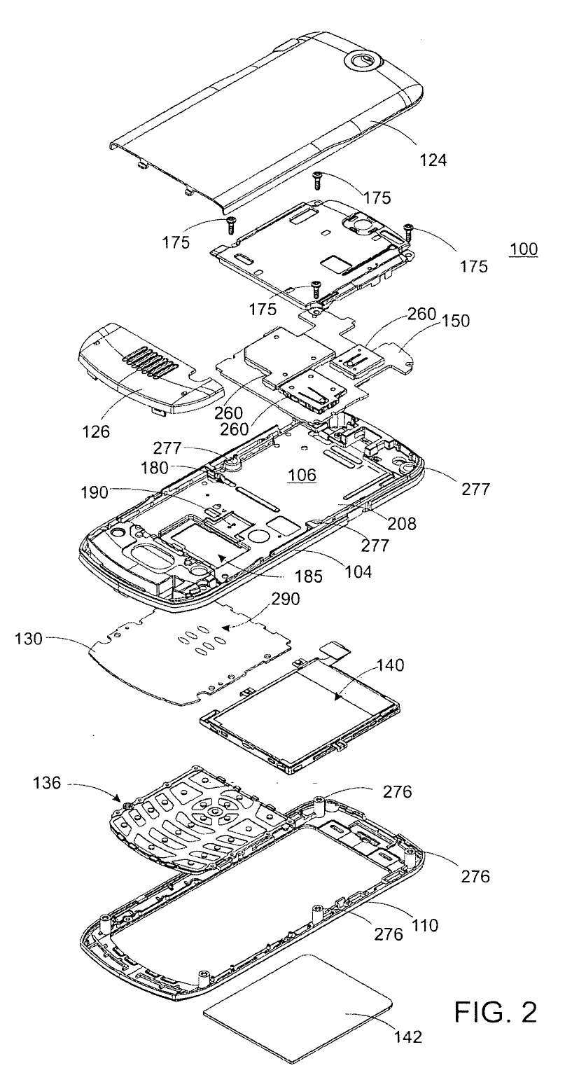

Referring to FIG. 2, there is illustrated an exploded rear view of the radio communications device 100 in which the partition 106 has a substantially planar second surface 208 and SIM card electrical contacts 290 are disposed on the keypad switch mount 130. The SIM card electrical contacts 290 are positioned such that when the device 100 is assembled the contacts 290 protrude into the removable memory card apertured region 185. Also, surface mounted on the circuit substrate 150 are processor and transceiver circuitry 260 (or other circuitry formed in an integrated circuit packages). More specifically, the circuit substrate 150 is a circuit board with surface mounted components surface mounted on opposite sides thereof, these surface mounted components include circuitry 160 and 260. As shown, there are boss receiving apertures 277 for receiving apertured threaded bosses 276, the bosses 276 being threaded for complementary threaded engagement with the fixing screws 175. Accordingly, when assembled, the threaded bosses 276 are located in respective boss receiving apertures 277 and the fixing screws 175 engage with the respective threaded bosses 276 thereby mounting the metal cover 170 to the circuit substrate 150, and the circuit substrate 150 and user interface housing member 110 to the chassis 102.

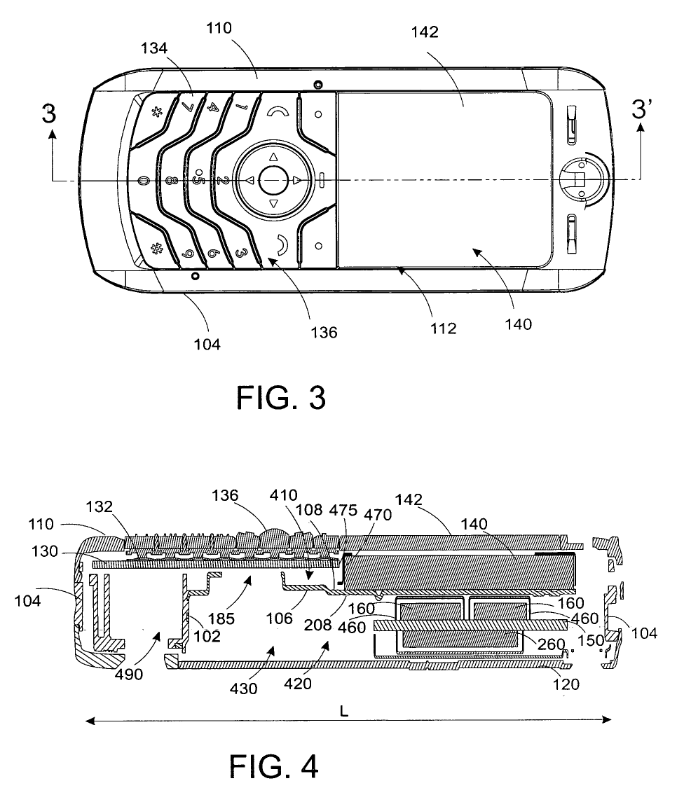

In FIG. 3 there is shown a front plan view of the radio communications device 100, when assembled in which the keypad 136 and screen lens 142 are located in the lens and keypad aperture 112. Also, when the radio communications device 100 is assembled the outer frame 104 forms outer edges of the device 100 and thus the frame 104 can be considered, in combination with housing members 110, 120, as forming part of the housing.

FIG. 4 illustrates an area cross sectional view through 3-3′ in which elements of the assembled radio communications device 100 that are disposed along 3-3′ are illustrated. It should be noted that for ease of illustration the device 100 is distorted to be thicker than it actually would be. When assembled, the user interface housing member 110 is mounted to the chassis 102 to form at least one user interface component chamber 410 with the with the first surface 108 of the partition 106, and the opposite housing member 120 being mounted to the chassis 102 to form at least one other component chamber 420 with the second surface 208 of the partition 106. The keypad switch mount 130 is disposed in the user interface component chamber 410 and is supported by the first surface 108 of the partition 106, similarly, the display screen 140 is disposed in the user interface component chamber 410 and the supported by the first surface 108 of the partition 106.

In contrast, there is a battery chamber 430 formed in the other component chamber 420 and the circuit substrate 150 is disposed in the other component chamber 420 is supported by the second surface 208 of the partition 106. In this covers 460 over circuitry 160 abut the second surface 208 thereby providing support for the circuit substrate 150. When assembled, the speaker chamber cover and chassis 103 provide an acoustic speaker chamber 490 for accomodating a loud speaker (not shown).

As shown, display screen 140 and keypad switch mount 130 are located in a substantially juxtaposition relationship such that respective facing edges 470,475 are adjacent each other. Similarly, the battery chamber 430 and circuit substrate 150 are located in a substantially juxtaposition relationship. Furthermore, the battery chamber 430 is located proximal to the keypad switch mount 130 and the circuit substrate 150 is located proximal to the display screen 140. There is no processor and transceiver circuitry 160 (or other circuitry formed in integrated circuit packages) surface mounted on the keypad switch mount 130 whereas there is processor and transceiver circuitry 160 (and other circuitry formed in integrated circuit packages) surface mounted on opposite sides if the circuit substrate 150. Also the keypad switch mount 130 and the display screen 140 are located to be in a non-overlapping longitudinal relationship along a longitudinal axis identified by arrowed axial line L. The keypad switch mount 130 and circuit substrate 150 are also located to be in a non-overlapping longitudinal relationship along the longitudinal axis identified by arrowed axial line L.

Advantageously, the present invention provides for a relatively thin radio communications device, therefore providing elegance and convenience that are beneficial to users of such devices that are often refer to as “candy bar shaped”.

In the foregoing specification, a specific embodiment of the present invention has been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

We claim:

1. A radio communications device comprising:
a chassis having an outer frame with at least one partition disposed therein;
a substantially rigid housing having at least a user interface housing member and at least one opposite housing member, the user interface housing member being mounted to the chassis to form at least one user interface component chamber with the with a first surface of the partition, and the opposite housing member being mounted to the chassis to form at least one other chamber with the with a second surface of the partition;
a keypad switch mount supporting a plurality of switch contacts aligned with respective keypad keys, the keypad switch mount being disposed in the user interface component chamber and supported by the first surface of the partition;
a display screen disposed in the user interface component chamber and supported by the first surface of the partition;
a battery chamber formed in the other component chamber; and
at least one circuit substrate with processor and transceiver circuitry mounted thereon, the substrate being disposed in the other component chamber and supported by the second surface of the partition.

2. A radio communications device as claimed in claim 1, wherein the partition is electrically conductive and forms a ground plane for the device.

3. A radio communications device as claimed in claim 1, wherein the partition has at least one substantially planar surface.

4. A radio communications device as claimed in claim 1, wherein the partition is formed from a metal sheet.

5. A radio communications device as claimed in claim 1, wherein the display screen and keypad switch mount are located in a substantially juxtaposition relationship.

6. A radio communications device as claimed in claim 4, wherein the battery chamber and circuit substrate are located in a substantially juxtaposition relationship.

7. A radio communications device as claimed in claim 5, wherein the battery chamber is located proximal to the keypad switch mount;

8. A radio communications device as claimed in claim 6, wherein the circuit substrate is located proximal to the display screen.

9. A radio communications device as claimed in claim 1, wherein the circuit substrate is a circuit board with integrated circuit packages surface mounted on opposite sides thereof.

10. A radio communications device as claimed in claim 8, wherein there are no integrated circuit package surface mounted on the keypad switch mount.

11. A radio communications device as claimed in claim 1, wherein the keypad switch mount and display screen are located to be in a non-overlapping longitudinal relationship.

12. A radio communications device as claimed in claim 1, wherein the keypad switch mount and circuit substrate are located to be in a non-overlapping longitudinal relationship.
